(19) United States
(12) Patent Application Publication
(10) Pub. No.: US 2010/0033739 A1
(43) Pub. Date: Feb. 11, 2010

(54) CUSTOMIZED CREDENTIAL AND METHOD AND SYSTEM OF PRODUCTION

(75) Inventors: Jeffrey Phelan, Herndon, VA (US); Charles Adams, Silver Spring, MD (US); Doron Enav, Burke, VA (US); John Glover, Fairfax, VA (US)

Correspondence Address: SHUTTLEWORTH & INGERSOLL, P.L.C., 115 3RD STREET SE, SUITE 500, P.O. BOX 2107, CEDAR RAPIDS, IA, 52406, US

(73) Assignee: I6 LLC, Kearneysville, WV (US)

(21) Appl. No.: 12/519,946

(22) PCT Filed: Dec. 19, 2007
(86) PCT No.: PCT/US07/25934

§ 371 Date: Jun. 18, 2009

Related U.S. Application Data
(60) Provisional application No. 60/875,547, filed on Dec. 19, 2006.

(51) Int. Cl. G06F 15/00

(52) U.S. Cl. 358/1.9; 358/1.15

(57) ABSTRACT

A batch of individualized credentials, e.g., ID tags, event tickets, etc., taken from a credential medium that includes respective polyoptic regions each carrying an encoded image set associated with respective individualized credentials, as well as a system and a method or producing the same. The production process uses credential data retrieved from a data store to create a plurality of individualized credentials on a single sheet medium. The dynamic production process enables inclusion of variable customer or patronage data, or individual object data (e.g., a serial number or object characteristic) on individual credentials using a template file that identifies a type of data to be retrieved from the data store and/or a specified image generated according to the value, nature, or type of the individualized data. Encoding of images may take the form of positioning, sizing, intensity, color, masking, interlacing, interleaving, scrambling, mixing, transformation, alteration, translation of pixels of images of multiple images.

This application is the national phase of international application PCT/US2007/025934 filed Dec. 19, 2007 which designated the U.S. and that international application was published under PCT Article 21(2) in English.

This application claims priority to provisional application No. 60/875,547, filed Dec. 19, 2006, which is incorporated by reference herein, in its entirety, for all purposes.

### BACKGROUND

1. Field of the Invention

The present invention relates to customized credentials, but more specifically to customized credentials produced from variable data as well as a system and method to make such credentials.

2. Introduction

As access to more valuable assets, information, and facilities is granted to the bearer of a personal ID credential, the importance of validating the bearer and information carried as well as securing the physical carrier of this information is dramatically increased. There are two major security questions surrounding any given credential: 1) is the person the rightful bearer of this credential, and 2) is the credential authentic.

The generation of credentials that can meet security criteria such as those identified above is typically an intensive process. What is needed therefore is a credential production system and method that would enable the efficient use and creation of secure credentials that incorporate data that is unique to the credential or the object or person bearing the credential.

### SUMMARY

According to a first aspect of the invention, there is provided a method of mass producing individualized credentials that comprises providing a template that identifies a specified type of data to be retrieved and a specified position to print an assigned image on a credential medium; sequentially retrieving from a data store the specified type of data where the retrieved data is unique to a respective individual person or object; for each retrieved data, assigning an image to the specified position on the credential medium based on a value/content/nature of said retrieved data; and for each retrieved data, printing the assigned image at the specified position on the credential medium to provide a view of the assigned image according to an angle of view of said medium, whereby to mass produce individualized credentials.

The assigned image may be a scalable vector graphics (SVG) and a postscript (ps) file, and may comprise a color, a frame of an animation, a background pattern, a picture, and text, or other visual manifestation including a scalable graphics file. Retrieved data may comprise biometric or biographic data of an individual person, text data, or other information. The data store may be a digital data stored in memory or a physical list of information (manually or automatically generated) from which data is obtained manually. The credential medium may comprise a composite of a lens layer, print, and/or coating(s); or simply a lens screen having print on a planar side thereof.

Another aspect of the invention comprises an apparatus to mass produce individualized credentials. Such an apparatus may comprise a data store that stores credential data for a plurality of unique credentials; a template that specifies an image and a position of printing the image on a credential medium; an image retrieval module in communication with the data store where the image retrieval module includes a processor responsive to the template to effect retrieval of the credential data from the data store and to assign an image to the credential based on a value/content/nature thereof, and a printer that, for each retrieved credential data, prints the assigned image at the specified position on the credential medium. A conventional processor programmed in a known manner to carryout data retrieval may be employed for this purpose.

A further aspect of the invention comprises a batch of customized credentials each comprising a credential medium embodying a print region and at least one polyoptic region overlying the print region; an encoded set of multiple images printed on the print region where at least one image of the encoded set is assigned to selective pixel positions on the credential medium according to information specified in a data store; and a series of respective lenses in the credential medium overlying the encoded set of images in the print region to enable viewing, according to view angle, of selective pixel positions that represent at least one image of the encoded set of images.

Selective pixel positions may comprise a series of pixel rows of an image or an interlaced or interleaved image. Encoding of the encoded set of image may take other forms including positioning, sizing, intensity, coloring, masking, interlacing, interleaving, scrambling, mixing, transformation, alteration, translation of pixels of images of the multiple images. The width of the pixel rows may range from one to a few pixels, or even a greater number, e.g., ten to even hundreds depending on the application (which may vary according to viewing distance, pixel density, printing constraints, etc.). The polyoptic region may comprise a series of convex or parabolic lenses aligned with respective pixels or pixel groups of interlaced images (e.g., slices of an image) printed on a medium underlying the lens elements to enable viewing of successive image frames of a view set of images according to view angle. The series of lenses may vary in frequency within or across a polyoptic region. Also, the polyoptic region may comprise a series of lenses registered with respective pixels of interlaced or interleaved images printed on a medium underlying the lenses to enable viewing of successive image frames of a view set of images according to view angle. An animation may thus be produced by sweeping the angle of view.

A system and method is disclosed for generating credentials using variable data, substantially as shown in and/or described in connection with at least one of the figures, and as set forth in the claims.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates an embodiment of a credential production process.

FIG. 2 illustrates an example of a credential medium and various image frames viewable upon a change of view angle.

FIG. 3 illustrates a flowchart of a process of generating credential image components based on credential data in a remotely or locally accessed database or data store.

FIG. 4 illustrates an example of data elements that may be incorporated into a credential.

FIG. 5 illustrates an example of a credential that uses a credential medium comprising a number of polyoptic or lens regions overlying a sheet medium.

FIG. 6 illustrates an example of layers incorporated into a finished credential formed on a portion of print grid.

FIG. 7 illustrates an example of interlaced image frames viewable in accordance with placement of pixel elements of respective image frames on a medium.

FIG. 8 illustrates an example of view sets (e.g., sets of image frames) viewable on respective regions of a credential medium in accordance with a change in view angle or viewing position.

FIG. 9 illustrates an example of encoding or pixel interlacing to create an underlying combined or interlaced image embodying respective image frames the become separately viewable in response to a change in viewing angle or position.

FIG. 10 illustrates an example of assembling multiple polyoptic regions to produce a credential.

FIG. 11 illustrates an example of tiling multiple credentials on a sheet medium.

### DETAILED DESCRIPTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

In general, a credential can represent any printed item utilized to identify and/or authenticate an individual, item, or representation of an individual or item. Examples of a credential include identity cards, citizen cards, driver's licenses, passports, work permits, breeder documents (e.g., social security card, birth certificates, etc.), social/medical benefits cards (e.g., health, dental, prescription, vision, unemployment, etc), tickets to an event, labels, seals, tags, packaging, certificates of authenticity, container seals, etc. As would be appreciated, the principles of the present invention can be applied in various industries or markets such as advertising, promotions, software, pharmaceuticals, tobacco, spirits, replacement parts, luxury goods, banknotes, IDs, packaged entertainment, ticketing, etc.

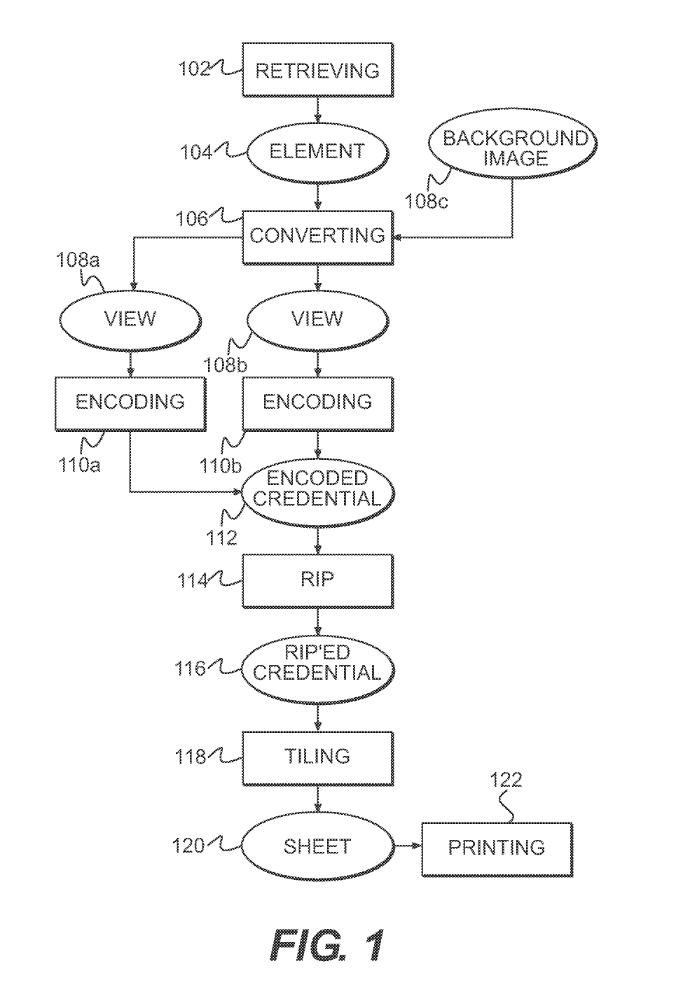

FIG. 1 illustrates an embodiment of a credential production process. To facilitate the construction of credentials, the credential production process can be described in relation to a system that mimics an assembly line, wherein raw biometric and biographic data is used to create a finished credential. As will be described in greater detail below, the credential production process is designed to produce unique credential images based on credential specific stored data.

In accordance with the present invention, the credentials produced by the credential production process are created using polyoptically encoded images. Here, credential information is printed directly onto a controlled credential medium, film, or material including a series of lens element formed therewith or thereon. As the credential medium is dynamically matched to the encoding process in the credential processing engine, (e.g., the placement of pixels of respective image frames is aligned or registered with overlying polyoptic lenses) any attempt to print an image on any other medium would result in a distorted image that is easily recognized as a fake.

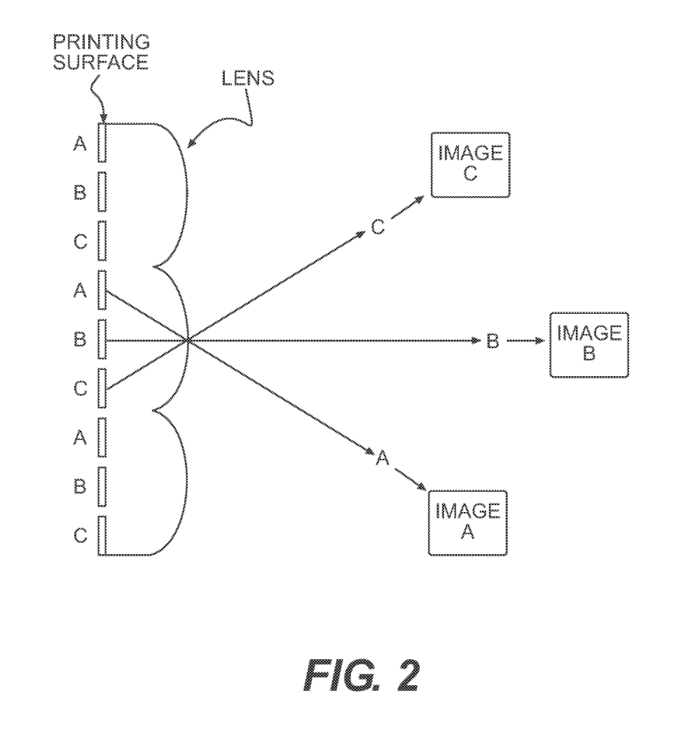

A polyoptically-encoded image is formed using a printed image and a credential medium through which the printed image is viewed. FIG. 2 illustrates an example of a credential medium. In one embodiment, the credential medium is a sheet of plastic on which a series of convex or parabolic polyoptic lenses are molded in parallel rib-like rows. Each of the individual polyoptic lenses magnifies a narrow strip of the image that is printed on the surface behind the lens elements. Alternatively, the printed images can also be placed on a separate sheet and joined with the lens layer. As illustrated, three strips taken from respective images A, B, and C are printed behind each lens element. In this arrangement, as the viewer changes the angle of view, the strip that is being magnified by lenses also changes. The resulting change between images A, B, and C in association with the change in angle of view produces an animation effect between images A, B, and C.

As illustrated, the credentials move through six different stages of processing, starting with raw data and ending with a finished physical credential. The stages are illustrated as follows: retrieval stage 102, which includes data element retrieval from the data store; converting stage 106, which includes conversion of the raw data into graphical elements; encoding stage 110, which includes encoding of the graphical elements for viewing through the credential medium; a RIP'ing (raster image processing) stage 114 which includes converting the image to a print-ready format; tiling stage 118, which includes consolidation of multiple credentials onto a single sheet for printing, and printing stage 122, which includes physical printing of the credentials.

These six stages are processed, in order. In various scenarios, there may be dependencies between the different stages depending on the complexity of the credential, such as data characteristics, polyoptically based effects, printing hardware, etc. In certain cases, the order of processing may vary and certain steps may be omitted. Additional steps may also be incorporated.

As illustrated, stages produce artifacts that are described herein as products. These products represent partially finished components of the final credential. For example, the first product is produced by retrieval stage 102, which product is consumed by converting stage 106. Each stage may produce more than one of these products. In the embodiment of FIG. 1, the five illustrated products include the following: element product 104, which includes the raw data (biometric, biographic, or any unique identifying information such as a bar code, serial number, product tag, etc.) of the credential; view product 108a and 108b (108c is a background image), which includes a subset of a polyoptic view of the credential, layer product 112, which includes a single image layer of the credential, credential product 116, which includes a print-ready representation of the credential, and sheet product 120, which includes a print-ready layout of a plurality of credentials. The final result of the process is the finished, printed credential, which is produced by printing stage 122.

Retrieval stage 102 is the first stage and includes basic setup and packaging of data. The input to retrieval stage 102 is the credential's ID, which is used to universally describe a single credential throughout its entire lifetime.

A primary purpose of retrieval stage 102 is to take a credential ID and retrieve all relevant data. In one embodiment, retrieval stage 102 would retrieve biographic text data, biometric graphic data, and template data that will be used in constructing the credential. In one embodiment, the template data defines what data is to be included in the credential, where data is to be placed (layout), and any dynamic data relationships. This retrieved data is packed into an element product, which would then be consumed by the subsequent converting stage 106.

As noted, retrieval stage 102 can be designed to retrieve personal information such as biometric text data (e.g., name, address, security level, seat number, etc.) and biometric graphic data (e.g., picture, fingerprint, or any other unique identifying formation such as a bar code, SKU number, etc.). In one embodiment, retrieval stage 102 can also be designed to determine and retrieve personalized data relationships. In general, the appearance of any element or set of elements may be modified based on information derived through dynamic data relationships defined in a credential template. For example, a dynamic data relationship can be defined that would generate a certain advertisement on an admission ticket based on a row number for the ticket. As would be appreciated, the dynamic data relationship can be driven by any piece of data that is associated with a given credential.

In one embodiment, defining a template involves two separate processes: 1) identifying the personal data elements and specifying where on the design surface these elements are to be placed, and 2) specifying any relationships between two or more data elements such that a specific value of a first element determines some characteristic of a second element. For example, the employee type (e.g., contractor, full-time, part-time) could determine the color of the frame around the employee's portrait, the border around the credential, or any other visual element on the credential. For example, a contractor status could dictate the use of a red border, a full-time status could dictate the use of a green border, while a part-time status could dictate the use of a blue border. While this example illustrates the use of a first element value to determine the color of a second element, other dynamic relationships can also be used between multiple elements. In various embodiments, a first element value can be used to determine such characteristics as the identity, size, location, etc. of a second set of elements.

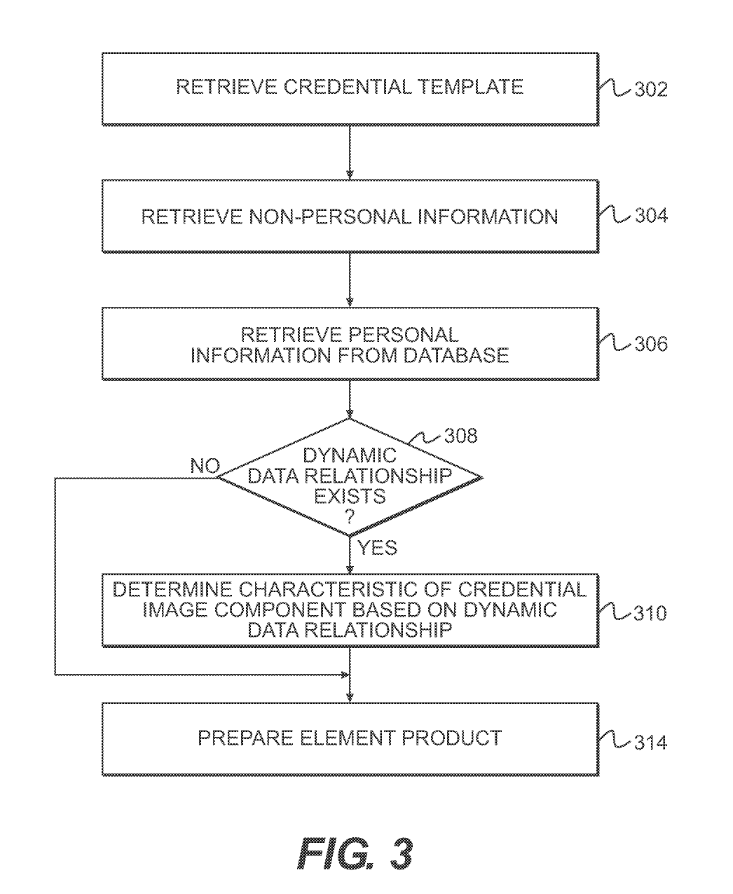

FIG. 3 illustrates a flowchart of a process of retrieving all relevant data based on a credential ID. In the embodiment of FIG. 3, the process begins at step 302 where a credential template is retrieved. In general, the credential identifies the relevant pieces of data that are used in constructing the credential, as well as element location, visual characteristics, etc.

At step 304, non-personal information is retrieved. This non-personal information can represent any piece of data that would be common to all of the credentials that are produced using the credential template. For example, the non-personal information can include a company logo, product information, background data, foreground data, etc. that would be printed on all credentials produced using the retrieved template.

Conventional production systems that produce credentials on credential medium are typically limited to the use of non-personal information. In other words, conventional production systems are typically geared towards generating an entire print run of identical credentials.

It is a feature of the present invention that individual credentials in a single production run can be customized for a particular person, product, event, etc. This customization enables each individual credential in a sheet of credentials to include image components that are distinct from the other credentials on the sheet. As will be described in greater detail below, this customization is facilitated by, for example, an external data store driven production process that integrates customized data on a credential-by-credential basis in an automated fashion.

One piece of customized data that is utilized is personal information. In the flowchart of FIG. 3, personal information is retrieved from a memory device at step 306. Such memory may reside on a local server access via a network, or on an Internet server. As noted above, in one example, personal information can include biometric text data (e.g., name, address, security level, seat number, etc.) and biometric graphic data (e.g., picture, fingerprint, etc.). Each of these pieces of personal information would be unique across a subset of the entire credentials produced by the production run. For example, if the personal information represented a driver's license number, then the personal information would be unique to all of the credential. Alternatively, if the personal information represented a company division number, then the personal information would be unique to the set of credentials issued to all of the division members.

Personal information is retrieved from a data store using a credential identifier. This unique identifier is used to retrieve the variable data in the data store that is identified by the variable data names in the credential template. After all of the personal information is retrieved from the data store for a given credential identifier, the process then determines whether to dynamically alter the appearance of existing elements or inclusion of additional elements base again on the dynamic data relationships specified in a currently used template.

This additional customized data is referred to as personalized data, which is retrieved using defined dynamic data relationships. In general, a dynamic data relationship can specify a relationship between two or more data elements such that a specific value of a first element determines some characteristic (e.g., identity, size, location, etc.) of a second element. At step 308, it is determined whether any such dynamic data relationships have been defined by the credential template. If no dynamic data relationships have been defined, then the process continues to step 314 where an element product is prepared using the non-personal and personal information that were previously retrieved.

If it is determined at step 308 that a dynamic data relationship has been defined by the credential template, then the process continues to step 310 where a characteristic of an image component is determined using the dynamic data relationship. As would be appreciated, various dynamic data relationships can be defined that would influence a visual characteristic of that particular credential. One benefit of such dynamic data relationships is the creation of distinguishable classes that would be readily apparent from a visual inspection of an individual credential by changing an angle of view. For example, if the dynamic data relationship dictated a particular border color based on a security level, then a quick visual inspection of the border color on the credential would provide easy discernment at a checkpoint. In another example, a dynamic data relationship could be defined that would dictate the inclusion or exclusion of a particular logo based on a customer status. In these and various other examples, the creation of distinguishable credential classes can be rapidly accomplished through the definition of dynamic data relationship functions within a credential template.

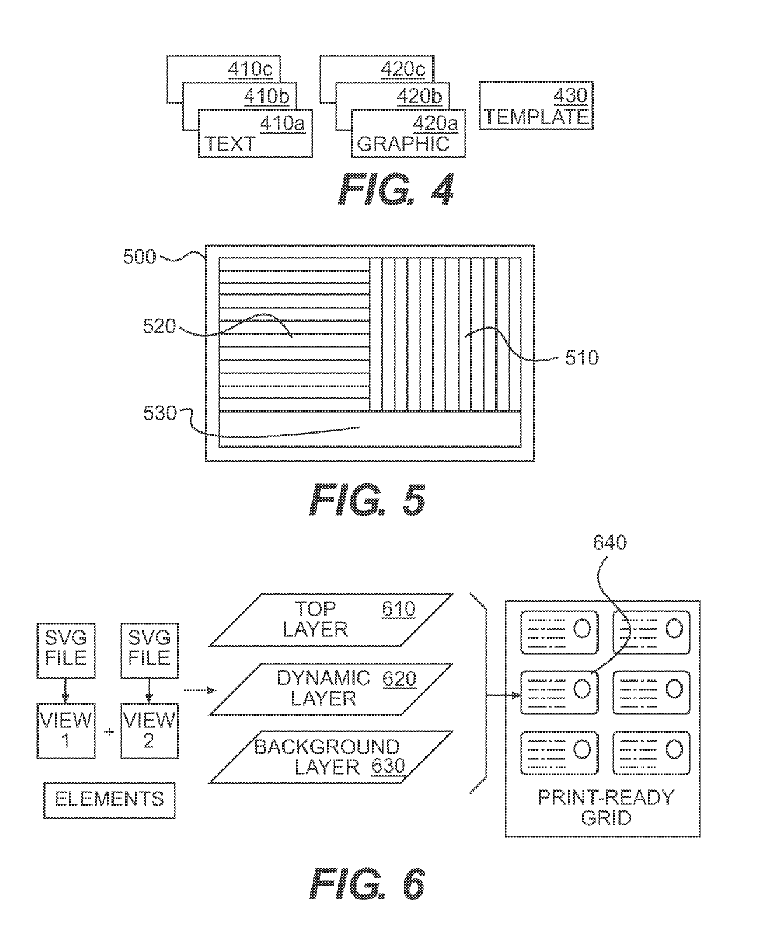

FIGS. 4 and 5 illustrate an example of the relation between retrieved data and a credential. In this example, personal and non-personal information such as biometric text data 410a, 410b, 410c, biometric graphic data 420a, 420b, 420c, and template data 430 are retrieved by retrieval stage 102. As would be appreciated, personalized data based on dynamic data relationships could also be retrieved by retrieval stage 102 as noted above.

As illustrated, image data based on the retrieved data is placed onto a print medium of credential medium 500 (see FIG. 5). Medium 500 also has a variable lens structure. This variable lens structure provides a plurality of regions 510, 520, 530 that have different effects upon changing view angles of the medium. In this particular example, region 510 has lenses arranged in horizontal rows, thereby producing a vertical polyoptic effect when the view angle is swept vertically. Region 520, on the other hand, has lenses arranged in vertical rows, thereby producing a horizontal polyoptic effect when the view angle is swept horizontally. Finally, region 530 is designed to produce no effect. It should be noted that in this example, different regions of a credential medium are produced using different orientations of lenses. In other examples, different regions of a credential medium can be produced by sets of lenses having different configurations, focal points, frequencies, lens shapes, and/or orientation.

In the example of FIG. 5, biometric text data 410a, 410b, 410c are mapped to region 510, biometric graphic data 420a, 420b, 420c are mapped to region 520, and data identified by template 430 is mapped to region 530. In this arrangement, the credential produced by credential medium 500 would produce a first animation in region 510 when the view angle of the credential is moved in relation to the eye horizontally and a second animation in region 520 when the view angle of the credential is moved in relation to the eye vertically. In general, one or more effects can be obtained by moving the credential in any direction relative to the eye, which change would create a view of different image data printed on the medium of the credential medium.

Converting stage 106 operates on element product 104 produced by retrieval stage 102. Here, all of the text data in element product 104 is extracted and rendered as graphical elements and all of the graphics data (including the rendered text) are scaled and processed to match the template's specifications.

FIG. 6 illustrates an embodiment of a conversion process based on a template defining a plurality of layers. In the example of FIG. 6, the template defines three layers: top layer 610, dynamic layer 620, and background layer 630. Both top layer 610 and background layer 630 can include static images that are predefined components of the design template. Dynamic layer 620, on the other hand, incorporates dynamic elements such as personal information and personalized data that change from one credential to another. As illustrated, in FIG. 6, dynamic layer 620 is designed to incorporate two views (i.e., source images) that are auto-generated from templates, and personalized data elements that are generated based on pre-defined dynamic data relationships.

The three layers 610, 620, and 630 are combined into a single composite image for a single credential 640 in a print-ready grid. Here, it should be noted that each credential in the print-ready grid would have data that is generated by its own respective dynamic layer. Accordingly, each credential in the print-ready grid would be distinct from each other since it is based on a unique set of personalized data. As noted, this aspect of the production process is in sharp contrast to conventional production processes that are used to generate a print-ready grid containing an identical set of credentials. It is therefore a feature of the present invention that the use of dynamic data relationships in the credential production process enables targeted marketing or awareness to the viewer of the credential. The flexibility and speed gained in the credential production process is a key factor in producing credentials with targeted characteristics on a large scale.

The print-ready grid that is ultimately generated is designed for application to a credential medium having a plurality of regions for each credential. Each of the plurality of regions has a lens orientation, shape, focal point, size, frequency or other characteristic that is designed to produce a different polyoptic effect for respective interlaced of source images printed on the underlying medium. Each individual source image of an interlaced view set is called a view, and a set of source images is called a view set. As the credential is moved relative to the eye, e.g., upon changing view angles, a different view in a view set becomes visible. In this way, a view is similar to a single frame of an animation. Rather than the views changing over time during sweeping of view angles, the views may change depending on the orientation of the credential. The views are grouped together in a view set based on the template specifications.

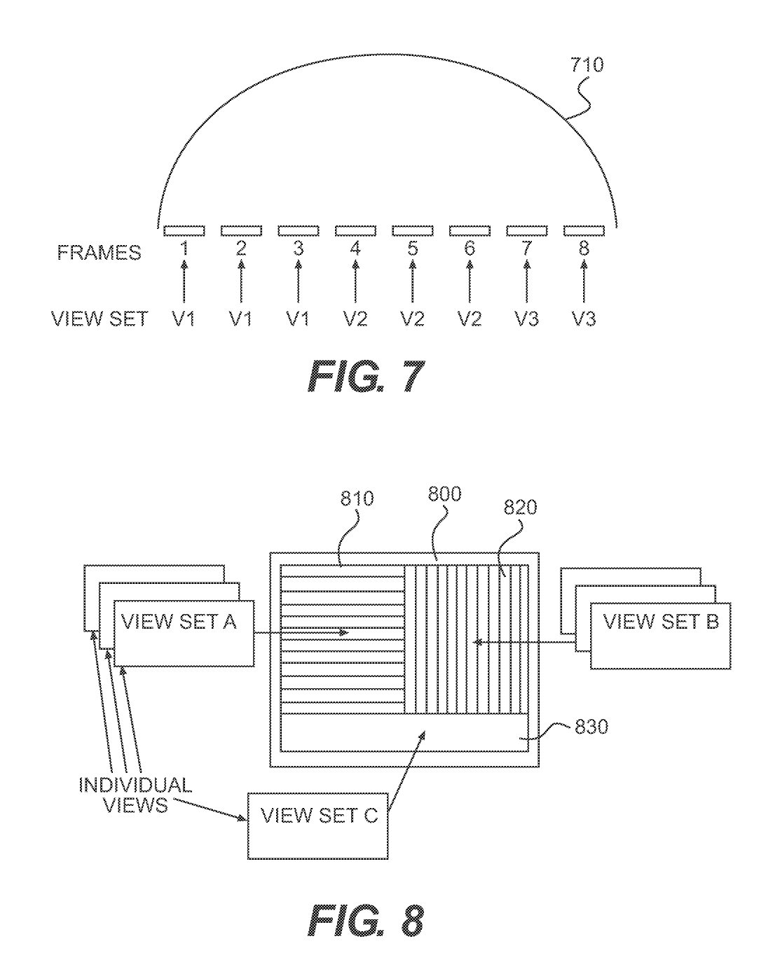

FIG. 7 illustrates the relation between frames and a view set. As illustrated, printed on the medium behind lens element 710 is a set of addressable frames 1-8 that respectively become visible behind lens 710 depending on the view angle. In one example, these eight addressable frames would result when an 800 dpi printer is used with a polyoptic area having 100 lenses/inch (lpi).

Each view in a view set is assigned to one or more frames. In the example of FIG. 7, views V1, V2, and V3 are assigned to frames 1-8. As illustrated, view V1 is assigned to frames 1-3, view V2 is assigned to frames 4-6, and view V3 is assigned to frames 7-8. In this assignment, the animation of views V1, V2, V3 in the view set would be seen as lens 610 sequentially brings the data in frames 1-8 into view. Other printer densities and lens frequency may be employed to define different assignments.

For example, if an effect is desired wherein all the text images are to change from red to blue to green, then the following three template files are defined: one that specifies the text elements as red, one that specifies the text elements as blue, and one that specifies the text elements as green. Here, each template element defines a view of the data that will be encoded with all the other views to create the dynamic layer of the credential.

Each of these views is then assigned to some set of underlying frames. If eight frames exist and a smooth color change is desired, then the first view can be assigned to frames 1-3, the second view assigned to frames 4-6, and the third view assigned to frames 7-8. This view-to-frame assignment can be handled by credential medium mask parameters in the template. For example, each view element can have a plurality of values that specifies the view number and the number of frames on which that view will appear. In the above example the credential medium mask would look as follows: View(1,3); View(2,3); View(3,2). Here, there are three views. View 1 is placed on the first three frames, view 2 is placed on the next three frames and view 3 is placed on the last 2 frames. The result of looking at this encoded image would then be a transition of the font color from red to blue to green as the credential was moved relative to the eye.

FIG. 8 illustrates the relation between view sets and regions on a credential medium. As illustrated, credential medium 800 includes regions 810, 820, and 830. Region 810 defines a vertical polyoptic effect and has view set A assigned to it. View set A consists of three individual views. Region 820, on the other hand, defines a horizontal polyoptic effect and has view set B assigned to it. View Set B also may consist of three individual views. Lastly, region 830, defines a no effect region and has view set C assigned to it. View set C consists of a single view.

As illustrated, view sets A, B, and C span single regions on credential medium 800. It should be noted, however, that it is possible for a single graphic (or text) to span more than one region. In this case, the source images may be altered, cropped, or combined to create the appropriate views for a particular region.

In encoding stage 110, views created by converting stage 106 are encoded to create a single image. An encoded image is designed to be viewed under a credential medium and is specially formatted to display a single view depending on the angle at which the image is viewed.

Different types of polyoptic material can create different effects. It therefore follows that for each polyoptic effect a different encoding process can be used to encode the views. In one embodiment, there is a library of encoders, each one containing a distinct encoding process.

Each view set for a particular region on the credential medium can be encoded by a single encoder to create a single layer. Since there can be multiple effect types per credential, there can be multiple encoders in use at a single time, each one processing a different view set and creating a different layer. For example, polyoptic effects such as appear/disappear, color switch, color wash, image switch, movement, moving pattern, parallax, size change, etc. can be implemented.

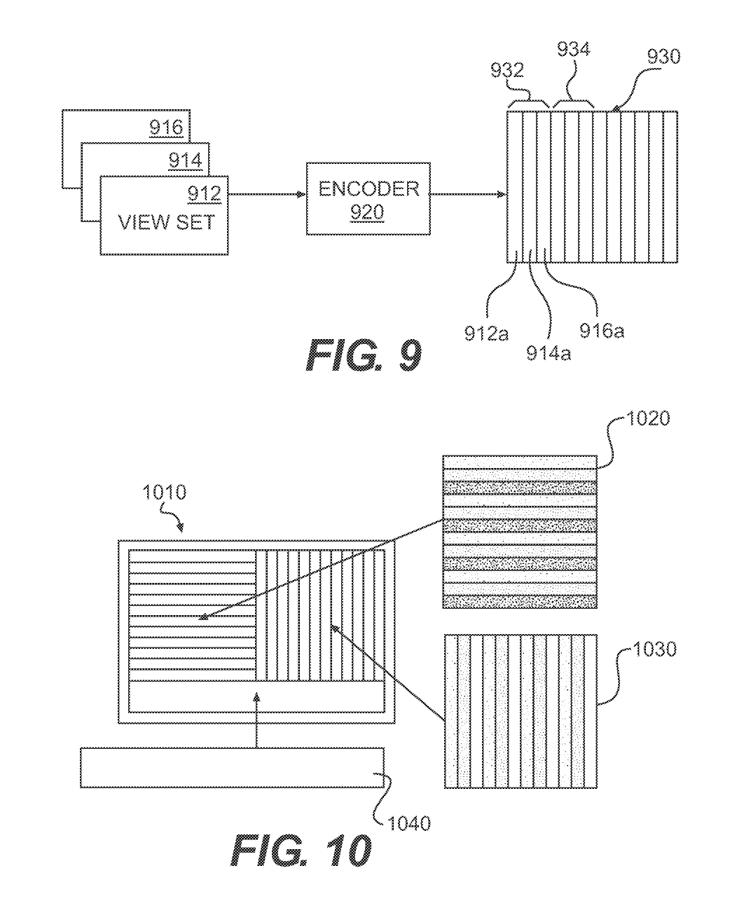

FIG. 9 illustrates an example of the encoding process. In this example, a view set having views 912, 914, and 916 are processed by encoder 920. In one embodiment, encoder 920 uses a bitmask encoder that encodes pixels of a series of input images together to form a final, polyoptic-oriented image using pre-determined, and cached, bitmasks (or polyoptic filters).

For each input image, a bitmask is created that represents which pixels should, or should not be included at a particular position on the print medium in the final encoded image. Which pixels are filtered out is governed by the desired credential medium configuration. This configuration could relate to different lens sizes, occurrences, directions, orientations, frequencies, or shapes. In one embodiment, these bitmasks are represented as a series of high (white) and low (black) pixels that mean include-this-pixel and do-not-include-this-pixel, respectively. After creation, the bitmasks are cached in memory where they can be used again and again.

During processing, each input image has its corresponding bitmask applied to it using a bitwise AND operation (e.g., any pixel which is non-black in both the input image and the bitmask is kept). Once each of the input images has been filtered, they are combined into a final, encoded image using a bitwise OR operation (e.g., keep any pixel which is non-black in any of the images).

In the example of FIG. 9, encoder 920 encodes bitmask segments 912a, 914a, and 916a (taken from views 912, 914, and 916, respectively) into an area 932 of layer 930. Area 932 is the area defined for a single lens in a polyoptic region. As illustrated, a second set of bitmask segments (also taken from views 912, 914, and 916, respectively) would be encoded into the next lens-defined area 934 of layer 930. This process would be repeated to cover the entire area 930.

The areas that were generated by encoding stage 110 are each pieces of the final credential, much like pieces of a puzzle.

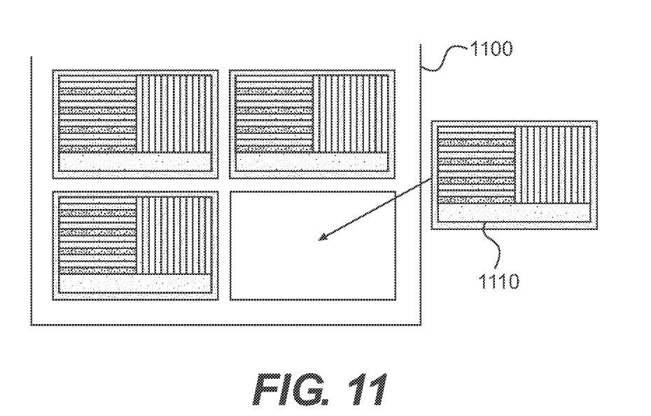

Once a credential is completed it must be converted to a print-ready format through the RIP'ing stage. Depending on the printer hardware it may be possible to fit more than one credential on a single sheet of credential medium, thereby allowing multiple credentials 116 to be printed at once. Tiling stage 118 creates a blank canvas, called a sheet, and then arranges one or more credentials 116 on sheet 120. Once sheet 120 is full, or there are no more credentials 116 to print, sheet 120 is sent to printing stage 122. FIG. 11 illustrates an example of the tiling process, where credential 1110 is added to sheet 1100.

Printing stage 122 is the final stage in creating a credential. Here, sheet 120, which contains a plurality of credentials, is printed to the credential medium. Printing stage 122 manages the printer hardware and delivers sheet 120 to the printer.

Depending on the printer hardware and configuration, this may be a direct request to the printer, the sheet file may be placed into some sort of “hot folder”, or some other mechanism may be used to print sheet 120. In one embodiment, printing stage 122 is hardware dependent to enable it to take full advantage of the hardware being used.

As sheet 120 includes a plurality of credentials, the image file produced by tiling stage 118 can be quite large. In one example, sheet 120 is embodied as a TIFF file that can be larger than 500 MB, though the system may be configured to write files with compressed formats specific to the individual printer used in the process.

In one embodiment, a streaming TIFF encoder is used to accommodate the large TIFF file sizes. This streaming TIFF encoder is a means by which exceptionally large TIFF files (e.g., 500 MB or higher) can be created and managed in such a way that only a fraction of the image remains in memory at any one time.

To create such an image, certain predefined data is known up front. These data include, but are not necessarily limited to: the final image dimensions, the color depth (e.g., 3-byte RGB, 4-byte CMYK, etc.), and individual tile dimensions. To construct the image, smaller “tiles” are created that represent smaller, isolated areas of the full image. Upon creation, a blank TIFF file is written piece-meal, wherein a standard TIFF header is written, followed by a section of small (1 to 4 bytes, generally), repeating picture elements representing a white (or some other solid color) field. Then, as each individual tile of the output image is generated, it is written to a specific section of the file so that it will appear in the correct location of the final, composite image.

These and other aspects of the present invention will become apparent to those skilled in the art by a review of the preceding detailed description. Although a number of salient features of the present invention have been described above, the invention is capable of other embodiments and of being practiced and carried out in various ways that would be apparent to one of ordinary skill in the art after reading the disclosed invention, therefore the above description should not be considered to be exclusive of these other embodiments. For example, although the illustrated polyoptic material is characterized by rows of lenticular lenses, a matrix or other pattern of lens elements may also be provided to generate polyoptic effects. An encoded image that makes up a view set may be interlaced, interleaved, combined or mixed by other patterns. Phraseology and terminology employed herein are for the purposes of description and should not be regarded as limiting. A database or data store may be a digital data stored in a memory device or a physical list of information (manually or automatically generated) from which data is obtained or retrieved manually. A lens may comprise any light-bending, frequency-shifting, or focusing medium of any shape. A polyoptic effect includes a change in visual effect in response to a change in view angle, whether in color, picture, motion, animation, visual effect, or any other visual phenomenon. Retrieval may be accomplished manually or electronically by a computer device. A medium or sheet on which an image is printed may comprise any natural or synthetic material that carries a printing substance, e.g., ink. Thus, the invention defined by the appended claims is not limited by the specific illustrations described above. Different embodiments can be formed by different combinations of the features described herein. It is intended that polyoptic and non-polyoptic regions can be placed on one or both sides of the credential medium.

What is claimed is:

1. A method of mass producing individualized credentials, said method comprising:
providing a template that identifies a specified type of data to be retrieved and a specified position to print an assigned image on a credential medium;
sequentially retrieving from a data store said specified type of data, said retrieved data being unique to a respective individual person or object;
for each retrieved data, assigning an image to said specified position on said credential medium based on a value/content/nature of said retrieved data; and
for each retrieved data, printing said assigned image at said specified position on said credential medium to provide a view of said assigned image according to an angle of view of said medium, whereby to mass produce individualized credentials.

2. The method of claim 1, wherein said assigned image comprises at least one of a color, a frame of an animation, a background pattern, a picture, and text.

3. The method of claim 2, wherein said specified position encompasses at least a portion of a printed credential.

4. The method of claim 2, wherein said retrieved data comprises biometric data of an individual person.

5. The method of claim 1, wherein said retrieved data comprises text data.

6. The method of claim 5, further comprising generating said assigned image based on said retrieved text data.

7. The method of claim 5, wherein said retrieved data comprises biographic text data.

8. The method of claim 1, wherein said assigned image comprises one of a scalable vector graphics (SVG) and postscript (ps) file.

9. The method of claim 1, wherein said template specifies a plurality of pairs of variable data names and position coordinates.

10. The method of claim 1, wherein said template identifies a second specified type of data to be retrieved and a second specified position to print a second assigned image on said credential, said method further comprising:
sequentially retrieving from said data store said second specified type of data thereby to obtain second retrieved data,
for each second retrieved data, assigning a second image to said second specified position on said credential medium based on a value/content/nature of said second retrieved data;
for each second retrieved data, printing said second assigned image at said second specified position on said credential medium to provide a view of said second assigned image according to an angle of view of said medium.

11. An apparatus to mass produce individualized credentials comprising:
a data store that stores credential data for a plurality of unique credentials;
a template that specifies an image and a position of printing said image on a credential medium;
an image retrieval module in communication with said data store, said image retrieval module including a processor responsive to said template to effect retrieval of said credential data from said data store and to assign an image to said credential data based on a value/content/nature thereof; and
a printer that, for each retrieved credential data, prints said assigned image at said specified position on said credential medium.

12. The system of claim 11, wherein said credential data comprises biometric information about a person.

13. The system of claim 12, wherein said credential data comprises demographic information.

14. The system of claim 11, wherein said assigned image includes one of a scalable vector graphics (SVG) and a postscript file.

15. A batch of customized credentials each comprising:
a credential medium embodying a print region and at least one polyoptic region overlying said print region;
an encoded set of multiple images printed on said print region where at least one image of said encoded set is assigned to selective pixel positions on said credential medium according to information specified in a data store; and
a series of respective lenses in said credential medium overlying said encoded set of images in said print region to enable viewing, according to view angle, of said selective pixel positions that represent said at least one image of said encoded set of images.

16. The customized credentials of claim 15, wherein said customized information comprises biographic information of an individual.

17. The customized credentials of claim 15 wherein each of said medium includes at least two of said polyoptic regions thereon.

18. The customized credentials of claim 15, wherein said at least one image comprises at least one of a color, text, background color, picture, a frame of an animation, etc.

19. The customized credentials of claim 15, wherein said series of respective lenses comprise a series of convex lenses aligned with respective pixels of said encoded set of images printed on said medium to enable viewing of successive image frames of a view set of images according to a changing view angle.

20. The customized credentials of claim 19, wherein said series of lenses vary in frequency within a polyoptic region.

21. The customized credentials of claim 15, wherein said polyoptic region comprises a series of lenses registered with respective pixel groups of said encoded set of images to enable viewing of successive image frames of a view set of images according to view angle.

22. The customized credentials of claim 21, wherein each image of said encoded set of images comprises an image frame of an animation.

23. The customized credentials of claim 21, wherein said encoded set of images effect a color change in response to a change in view angle.

24. The customized credentials of claim 15, wherein said images are encoded in one of positioning, sizing, intensity, color, masking, interlacing, interleaving, scrambling, mixing, transformation, alteration, translation of pixels of images of said multiple images.
